(19) United States
(12) Patent Application Publication
(10) Pub. No.: US 2016/0228766 A1
(43) Pub. Date: Aug. 11, 2016

(54) GAME CONTROLLER BUTTON EXTENDER WITH BIAS ADJUSTER

(71) Applicant: Aran N. Kissoon, Richfield, MN (US)

(72) Inventor: Aran N. Kissoon, Richfield, MN (US)

(21) Appl. No.: 15/016,418

(22) Filed: Feb. 5, 2016

Related U.S. Application Data
(60) Provisional application No. 62/112,320, filed on Feb. 5, 2015.

(51) Int. Cl. A63F 13/24

(52) U.S. Cl. CPC A63F 13/24

(57) ABSTRACT

A game controller button extender includes a trigger body having a top portion of the trigger body with a back shaped to mate with a game controller button. A bottom front portion of the trigger body extends away from the top back portion forming a front surface of the trigger body. An opening formed in the top portion of the trigger body is positioned to hold an adjustable depth protrusion extending away from the back of the top portion to contact a surface of the game controller adjacent the game controller button, such that the game controller button is biased as a function of a distance the protrusion extends away from the top portion of the trigger body.

### RELATED APPLICATION

This application claims priority to U.S. Provisional Application Ser. No. 62,112,230 (entitled Game Controller Button Extender with Bias Adjuster, filed Feb. 5, 2015) which is incorporated herein by reference.

### BACKGROUND

Buttons for game controllers are used to control many different aspects of an unlimited number of electronic games. Some buttons are resistive, and operate to provide electrical signals representative of the amount of pressure or depth of depression by a user. The signals may be used to simulate a trigger in a shooting game, a gas pedal in a driving game, or a myriad of other elements of an electronic game that may be designated to respond to interaction with the button. Some clip on trigger enhancements are available, but merely provide an enhancement to the size and shape of the buttons they clip on to.

### SUMMARY

A game controller button extender includes a trigger body having a top portion of the trigger body with a back shaped to mate with a game controller button. A bottom front portion of the trigger body extends away from the top back portion forming a front surface of the trigger body. An opening formed in the top portion of the trigger body is positioned to hold an adjustable depth protrusion extending away from the back of the top portion to contact a surface of the game controller adjacent the game controller button, such that the game controller button is biased as a function of a distance the protrusion extends away from the top portion of the trigger body.

A method includes adhering an extender to a button of an electronic game controller, adjusting a length of an adjustable length protrusion coupled to the extender to extending into a fixed surface of the electronic game controller to bias the button, and wherein while adjusting the length of the adjustable length protrusion, viewing an effect of the length on an aspect of the electronic game controlled by the button of the electronic game controller to obtain a desired biasing of the button.

A game controller extended button includes a body coupled to provide user input to the game controller. An arcuate surface of the body extends out from the game controller. An opening formed in a top portion of the body is positioned to hold an adjustable depth protrusion extending away from the back of the top portion to contact a surface of the game controller adjacent the button, such that the game controller extended button is biased as a function of a distance the protrusion extends away from the top portion of the body.

### BRIEF DESCRIPTION OF THE DRAWINGS

FIG. 1 is an exploded perspective view of an extender for coupling to a game controller button according to an example embodiment.

FIG. 2 is a perspective view of an extender coupled to a game controller button according to an example embodiment.

FIG. 3 is a perspective view of a back side of an extender for coupling to a game controller button according to an example embodiment.

FIG. 4 is a back view of an extender for coupling to a game controller button according to an example embodiment.

FIG. 5 is a side view of an extender for coupling to a game controller button according to an example embodiment.

FIG. 6 is a front view of an extender for coupling to a game controller button according to an example embodiment.

FIG. 7 is a side cross section view of extender taken along lines 6-6 from FIG. 6.

FIG. 8 is an enlarged view of a portion 8 of the cross section view of FIG. 7 according to an example embodiment.

### DETAILED DESCRIPTION

In the following description, reference is made to the accompanying drawings that form a part hereof, and in which is shown by way of illustration specific embodiments which may be practiced. The drawings are not necessarily to scale. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

A game controller extender couples to a button on an electronic game controller and includes an adjustable depth protrusion, such as a screw, to adjust a biasing of the game controller button. In one embodiment, the extender snaps into retentive contact with or is otherwise adhered to the button with the protrusion positioned to extend above the button to contact a fixed portion of the game controller. The length of the protrusion may be adjusted to partially depress the button, providing a user with the ability to adjust the amount of movement of the extender used to perform an action in the electronic game.

Where the button is a resistive based button used to simulate a trigger or gas pedal in the game, the protrusion allows adjusting the amount of pressure used to perform the desired action.

The extender may take different shapes, including a shape that is coextensive with the shape of the button but effectively extends the button outward and provides a concave surface for interaction with a finger of the user. In further embodiments, the extender further extends at least partially orthogonal to the direction of movement of the button, providing a larger range of motion to a user utilizing the further extension.

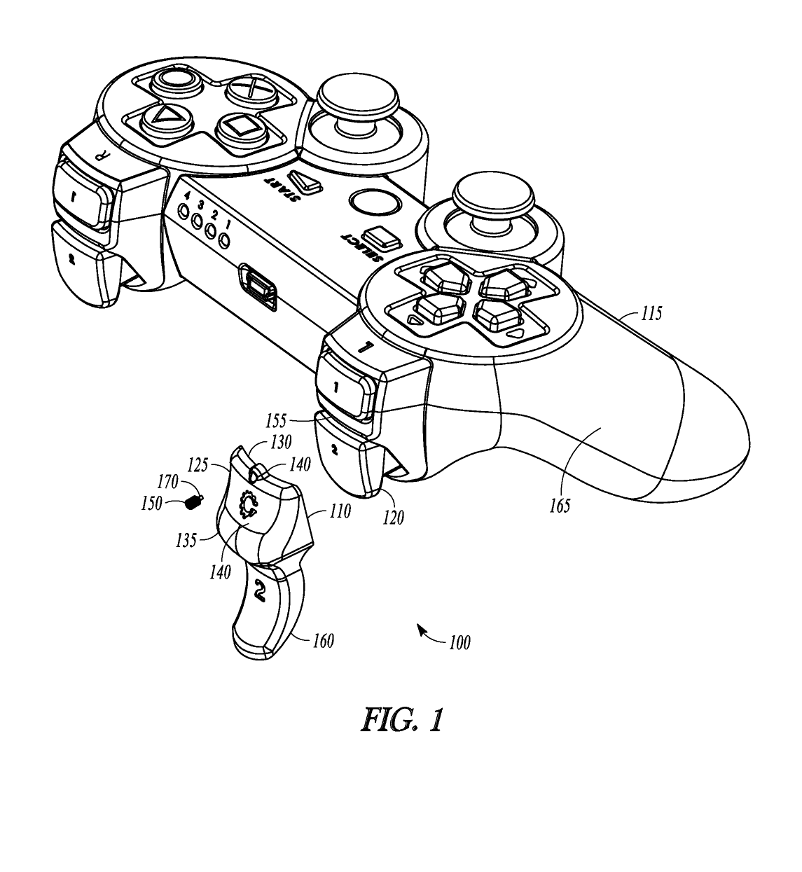

FIG. 1 is an exploded perspective view 100 of an extender 110 for coupling to a game controller 115 button 120. The extender 110 may be a molded plastic piece, or 3D printed, or otherwise formed, and includes a body 125 having a top portion 130 of the body 125 having a back shaped to mate with the game controller button 120. A bottom front portion 135 extending away from the top back portion forming a front surface 140 of the body 125. An opening 145 is formed in the top portion 130 of the body positioned to hold an adjustable depth protrusion 150, which when installed in the opening 145 extends away from the back of the top portion 130 to contact a surface 155 of the game controller 115 adjacent the game controller button 120, such that the game controller button 120 is biased as a function of a distance the protrusion extends away from the top portion 130 of the body 125. In various embodiments, the game controller button has a range of motion into an opening in the surface of the game controller. The term adjacent is used to signify that the protrusion extends in a manner to contact the surface near the opening, or at least such that it can function to bias or depress the button depending on the length the protrusion extends from the extender 110.

In one embodiment, the opening 145 comprises a threaded hole extending through the top portion and the adjustable depth protrusion 150 comprises a screw having a flat surface to contact the game controller surface. The opening may include a separate threaded portion formed of plastic, metal, or other stiff material suitable for being retained in the opening and providing mating threads for the protrusion. The opening in further embodiments may include a clip or other mechanism for adjusting a non-threaded protrusion, such as a ribbed rod, or piston, or other type of adjustable length mechanism.

In one embodiment, the bottom portion 135 covers the game controller button 120 and has a surface area coextensive with a surface of the game controller button 120. In a further embodiment, the bottom portion 135 extends away from the surface of the game controller button, forming a concave surface trigger portion 160 suitable for interaction with a finger of a user. The trigger portion may be angled away from the controller button 120 in a manner that provides good tactile feel for a user without interfering with expected gripping styles of the game controller 115. For instance, one side 165 of the game controller 115 may be gripped in the palm of a user, with an index or middle finger used to contact the controller button 120 via the extender 110. The range of motion of the trigger portion 160 should not interfere with other fingers while handling the game controller 115. The trigger may form an angle from the direction of motion of the button 120 that ranges from orthogonal to the direction of motion to several degrees beyond orthogonal to move the trigger further away from the button and side 165 of the game controller.

In one embodiment, the controller 115 may be a Sony PlayStation® controller, but may be any other type of controller in further embodiments. While the extender may be described as an add-on piece to a controller button, in some embodiments, the controller button may also include an integrated structure to provide an adjustable length protrusion. The integrated structure may include an adjustable length protrusion and may modify the profile of the button to have a similar profile to that described herein.

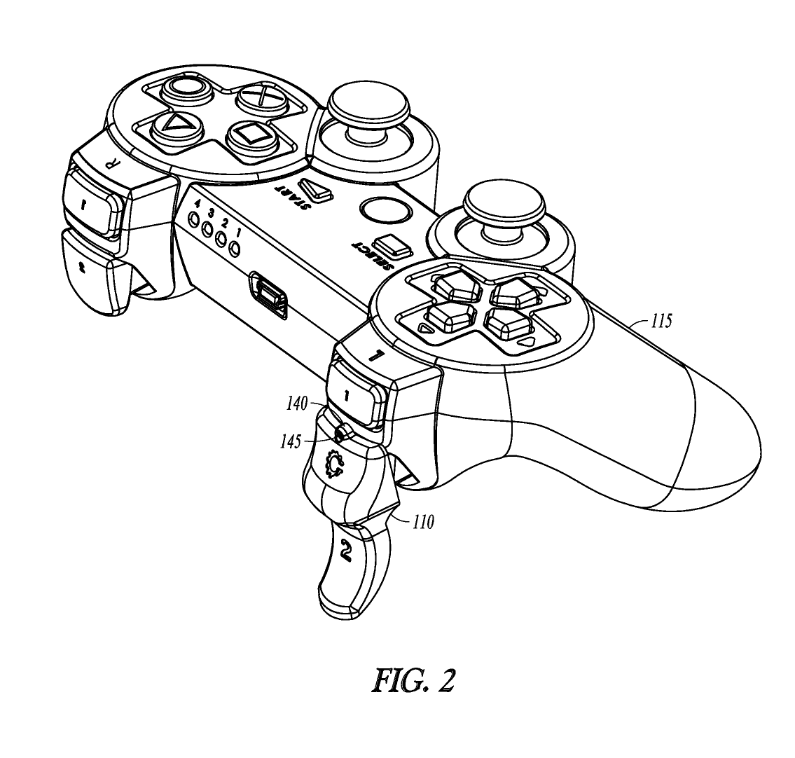

FIG. 2 is a perspective view of the extender 110 coupled to the game controller 115. The protrusion 150 is shown installed in the opening 140 and is pressing against surface 155 of the game controller 115. In one embodiment, the protrusion is a screw with a hex head for adjusting a protrusion depth. The tip of the screw may be a flat surface in one embodiment to avoid marring the surface 155. In addition, the opening may be positioned to form an angle to the surface 155 that is substantially orthogonal to the surface to minimize marring. Still further, the tip may be in the shape of a cone, or may including a nylon or other soft material tip 170 to further minimize marring.

In use, multiple surfaces may be used by a user in a two finger action mode. One finger, such as forefinger may be used to actuate the extender via front surface 140, while a second finger, such as a middle finger, may alternately be used to actuate the extender via trigger portion 160. Such a mode may increase the speed at which a user may actuate the button 120.

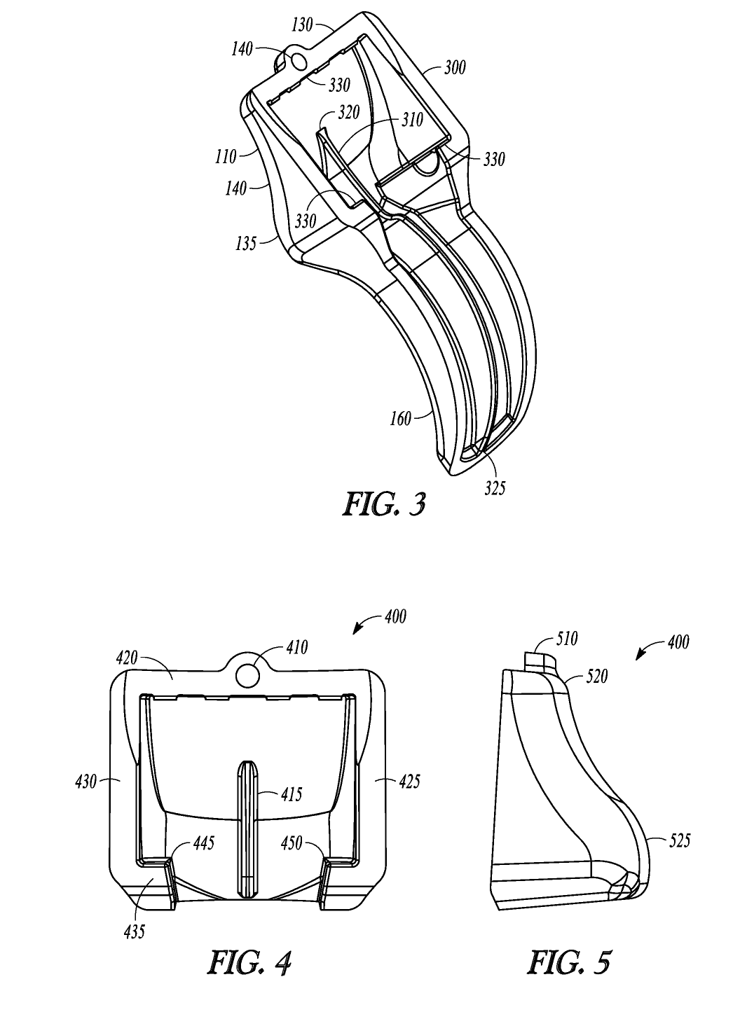

FIG. 3 is a perspective view of a back side 300 of the extender 110. The back side 300 includes one or more ribs 310 positioned along a length of the back side of the extender 110 to provide reinforcement for increasing the structural integrity and strength of the extender 110. In one embodiment, the rib runs longitudinally along a center of the extender 110. The rib or ribs in one embodiment provide an additional stiffness to the extender such that there is minimal bending of the extender 110 during use. The rib in one embodiment may be a single rib extending from the near the top portion 130 as indicated at 320 to a far end 325 of the trigger portion 160. The top portion of the rib may be recessed within the back of the extender 110 to allow for attachment to a game controller button. In further embodiments, multiple ribs may be used, including one or more longitudinal ribs as shown, and may also include any manner of cross hatching ribs.

One or more lips 330 may be included on the back side 300 to form snap fit portions of the extender 110. The ridges or rib 310 may be recessed into the back portion 300 to provide a cavity to allow the back portion 300 to fit over the button 120 such that the lips 330 snap into place behind a back of the button 120, into one or more recesses in button 120, or over a ridge or ridges on button 120 to be adhered to the button 120. Releasing the extender may be easily accomplished by either using the optional trigger portion to pry the extender off the button, or removing the protrusion 150 and using a hex wrench as a lever to pry the extender off the button.

In one embodiment, lip 330 extends over only a portion of the back side 300 of the extender 110, or over multiple selected portions depending on the amount of retentive force desired to either operate the button using the extender, or remove the extender. The lips 330 in one embodiment may include a top lip at the top portion 130 and two side lips on the bottom portion sides to snap onto a corresponding bottom of the button. The arcuate shape of the trigger portion 160 is illustrated in FIG. 3. Such shape may provide an enhanced ergonomic feel to a user.

FIG. 4 is a back view of an extender 400 illustrating an opening 410 for an adjustable length protrusion, and a back rib 415 for reinforcing the extender 400. The back of extender 400 includes a top edge 420, side edges 425, 430, and bottom edges 435, 440, which are shorter edges that partially extend in from sides 425, 430. The bottom edges 435 and 440 may include lip portions 445, 450 that serve as protrusions that snap onto the controller button 120.

FIG. 5 is a side view of the extender 400. From this view, the profile of the extender 400 is illustrated with a top portion having a bump 510 for positioning the opening 410 appropriately to contact a desired portion of the game controller body when the extender is snapped onto the bottom, or otherwise adhered to the button. The bump and opening may be easily modified for many different configurations of controller buttons and controller bodies to ensure the protrusion contacts the controller body at a position to minimize marring and/or optimize leverage and biasing adjustment of the button via the extender and adjustable length protrusion. A profile of the surface of the extender 400 extends in an arcuate shape from the top portion 520 to a bottom portion 525. The profile is a concave surface, with the bottom portion 525 extending further away from the button than the top portion. The concave surface may provide an ergonomic feel to the user.

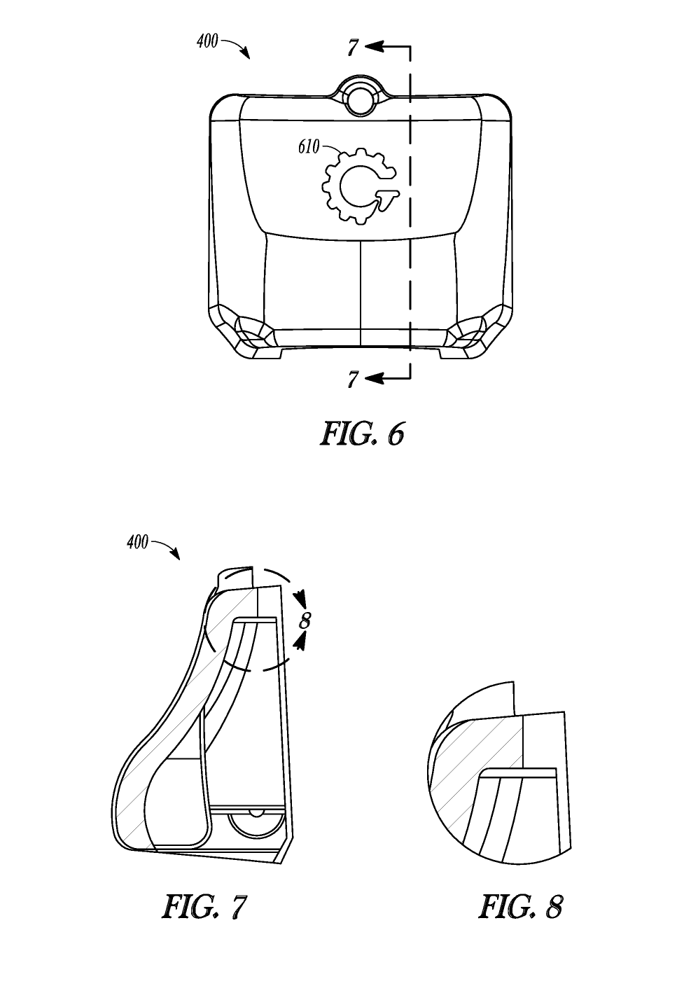

FIG. 6 is a front view of the extender 400, and may include a logo or other symbol indicated at 610.

FIG. 7 is a side cross section view of extender 400 taken along lines 6-6 from FIG. 6. A circle 8 identifies a portion of extender 400 in FIG. 7 which is shown in an enlarged cross section in FIG. 8.

In one embodiment, the length of the adjustable length protrusion may be adjusted using a suitable tool, such as a screwdriver wherein the protrusion is a screw, or a hex wrench wherein the head of the screw is adapted to fit a hex wrench. The adjustment may be performed while the electronic game is active to observe an effect of the biasing of the button in the game. The ability to adjust the length of the protrusion provides the ability to have enhanced, custom tailored sensitivity that can dramatically affect the gaming experience.

A method of using the extender may include adhering the extender to a button of an electronic game controller and adjusting a length of an adjustable length protrusion coupled to the extender to extending into a fixed surface of the electronic game controller to bias the button. While adjusting the length of the adjustable length protrusion, the effect of the length on an aspect of the electronic game controlled by the button of the electronic game controller may be viewed to obtain a desired biasing of the button.

In further embodiments, the extender may be integrated with the button and formed as a single injection molded piece. Such an integrated extender would obviate the use of lips to form a snap fit with an existing button, as the button itself would be formed with an adjustable length protrusion. In one embodiment, a game controller extended button includes a body coupled to provide user input to the game controller. The button body thus includes the button and may be installed in the game controller in the same manner as the button. An arcuate surface of the body extends out from the game controller. An opening formed in a top portion of the body of the button is positioned to hold an adjustable depth protrusion extending away from the back of the top portion to contact a surface of the game controller adjacent to the button, such that the game controller extended button is biased as a function of a distance the protrusion extends away from the top portion of the body.

### EXAMPLES

1. A game controller button extender comprising:
a trigger body;
a top portion of the trigger body having a back shaped to mate with a game controller button;
a bottom front portion extending away from the top back portion forming a front surface of the trigger body; and
an opening formed in the top portion of the trigger body positioned to hold an adjustable depth protrusion extending away from the back of the top portion to contact a surface of the game controller adjacent the game controller button, such that the game controller button is biased as a function of a distance the protrusion extends away from the top portion of the trigger body.

2. The game controller button extender of example 1 wherein the back of the top portion comprises ridges to provide a snap fit retentive mating with the game controller button.

3. The game controller button extender of any of examples 1-2 and further comprising the adjustable depth protrusion.

4. The game controller button extender of example 3 wherein the opening comprises a threaded hole extending through the top portion and the adjustable depth protrusion comprises a screw having a flat surface to contact the game controller surface.

5. The game controller button extender of example 4 wherein the threaded opening is positioned such that the adjustable depth screw contacts the surface of the game controller substantially orthogonal to the surface.

6. The game controller button extender of any of examples 1-5 wherein the button the back of the top portions mates with is a pressure sensitive button.

7. The game controller button extender of example 6 wherein the adjustable protrusion applies more biasing pressure to the pressure sensitive button the deeper the protrusion extends out the back of the top portion of the button.

8. The game controller button extender of any of examples 1-7 wherein the bottom portion extends away from the top back portion and beyond a surface of the game controller button and is shaped to be receptive to a user finger.

9. The game controller button extender of example 8 wherein the bottom portion has a shape of a trigger.

10. The game controller button extender of any of examples 1-9 wherein the trigger body covers the game controller button and has a surface area coextensive with a surface of the game controller button.

11. The game controller button of example 10 wherein the bottom portion of the trigger body extends away from the surface of the game controller button, forming a concave surface suitable for interaction with a finger of a user.

12. A method comprising:
adhering an extender to a button of an electronic game controller;
adjusting a length of an adjustable length protrusion coupled to the extender to extending into a fixed surface of the electronic game controller to bias the button; and
wherein while adjusting the length of the adjustable length protrusion, viewing an effect of the length on an aspect of the electronic game controlled by the button of the electronic game controller to obtain a desired biasing of the button.

13. A game controller extended button comprising:
a body coupled to provide user input to the game controller;
an arcuate surface of the body extending out from the game controller; and
an opening formed in a top portion of the body positioned to hold an adjustable depth protrusion extending away from the back of the top portion to contact a surface of the game controller adjacent the button, such that the game controller extended button is biased as a function of a distance the protrusion extends away from the top portion of the body.

14. The game controller extended button of example 13 and further comprising the adjustable depth protrusion.

15. The game controller extended button of example 14 wherein the opening comprises a threaded hole extending through the top portion and the adjustable depth protrusion comprises a screw having a flat surface to contact the game controller surface.

16. The game controller extended button of example 15 wherein the threaded opening is positioned such that the adjustable depth screw contacts the surface of the game controller substantially orthogonal to the surface.

17. The game controller extended button of any of examples 13-16 wherein the button is a pressure sensitive button.

18. The game controller extended button of example 17 wherein the adjustable protrusion applies more biasing pressure to the pressure sensitive button the deeper the protrusion extends out the back of the top portion of the button.

19. The game controller extended button of any of examples 13-18 wherein a bottom portion extends away from the top portion and is shaped to be receptive to a user finger.

20. The game controller extended button of example 19 wherein the bottom portion has a shape of a trigger.

21. The game controller extended button of example 20 wherein the bottom portion extends away from the surface of the game controller button, forming a concave surface suitable for interaction with a finger of a user.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A game controller button extender comprising:
a trigger body;
a top portion of the trigger body having a back shaped to mate with a game controller button;
a bottom front portion extending away from the top back portion forming a front surface of the trigger body; and
an opening formed in the top portion of the trigger body positioned to hold an adjustable depth protrusion extending away from the back of the top portion to contact a surface of the game controller adjacent the game controller button, such that the game controller button is biased as a function of a distance the protrusion extends away from the top portion of the trigger body.

2. The game controller button extender of claim 1 wherein the back of the top portion comprises ridges to provide a snap fit retentive mating with the game controller button.

3. The game controller button extender of claim 1 and further comprising the adjustable depth protrusion.

4. The game controller button extender of claim 3 wherein the opening comprises a threaded hole extending through the top portion and the adjustable depth protrusion comprises a screw having a flat surface to contact the game controller surface.

5. The game controller button extender of claim 4 wherein the threaded opening is positioned such that the adjustable depth screw contacts the surface of the game controller substantially orthogonal to the surface.

6. The game controller button extender of claim 1 wherein the button the back of the top portions mates with is a pressure sensitive button.

7. The game controller button extender of claim 6 wherein the adjustable protrusion applies more biasing pressure to the pressure sensitive button the deeper the protrusion extends out the back of the top portion of the button.

8. The game controller button extender of claim 1 wherein the bottom portion extends away from the top back portion and beyond a surface of the game controller button and is shaped to be receptive to a user finger.

9. The game controller button extender of claim 8 wherein the bottom portion has a shape of a trigger.

10. The game controller button extender of claim 1 wherein the trigger body covers the game controller button and has a surface area coextensive with a surface of the game controller button.

11. The game controller button of claim 10 wherein the bottom portion of the trigger body extends away from the surface of the game controller button, forming a concave surface suitable for interaction with a finger of a user.

12. A method comprising:
adhering an extender to a button of an electronic game controller;
adjusting a length of an adjustable length protrusion coupled to the extender to extending into a fixed surface of the electronic game controller to bias the button; and
wherein while adjusting the length of the adjustable length protrusion, viewing an effect of the length on an aspect of the electronic game controlled by the button of the electronic game controller to obtain a desired biasing of the button.

13. A game controller extended button comprising:
a body coupled to provide user input to the game controller;
an arcuate surface of the body extending out from the game controller; and
an opening formed in a top portion of the body positioned to hold an adjustable depth protrusion extending away from the back of the top portion to contact a surface of the game controller adjacent the button, such that the game controller extended button is biased as a function of a distance the protrusion extends away from the top portion of the body.

14. The game controller extended button of claim 13 and further comprising the adjustable depth protrusion.

15. The game controller extended button of claim 14 wherein the opening comprises a threaded hole extending through the top portion and the adjustable depth protrusion comprises a screw having a flat surface to contact the game controller surface.

16. The game controller extended button of claim 4 wherein the threaded opening is positioned such that the adjustable depth screw contacts the surface of the game controller substantially orthogonal to the surface.

17. The game controller extended button of claim 13 wherein the button is a pressure sensitive button.

18. The game controller extended button of claim 17 wherein the adjustable protrusion applies more biasing pressure to the pressure sensitive button the deeper the protrusion extends out the back of the top portion of the button.

19. The game controller extended button of claim 13 wherein a bottom portion extends away from the top portion and is shaped to be receptive to a user finger.

20. The game controller extended button of claim 19 wherein the bottom portion has a shape of a trigger.

21. The game controller extended button of claim 20 wherein the bottom portion extends away from the surface of the game controller button, forming a concave surface suitable for interaction with a finger of a user.
